(19) United States
(12) Patent Application Publication
(10) Pub. No.: US 2015/0375160 A1
(43) Pub. Date: Dec. 31, 2015

(54) RECOVERING H2 AND C2+ HYDROCARBONS FROM FUEL GAS VIA USE OF A TWO-STAGE PSA PROCESS AND SENDING PSA TAIL GAS TO A GAS RECOVERY UNIT TO IMPROVE STEAM CRACKER FEED QUALITY

(71) Applicant: UOP LLC, Des Plaines, IL (US)

(72) Inventors: Robert E. Tsai, Arlington Heights, IL (US); Xin X. Zhu, Long Grove, IL (US); Ronald J. Long, Arlington Heights, IL (US)

(21) Appl. No.: 14/743,407

(22) Filed: Jun. 18, 2015

Related U.S. Application Data
(60) Provisional application No. 62/017,827, filed on Jun. 26, 2014.

(51) Int. Cl. B01D 53/047

(52) U.S. Cl. CPC B01D 53/047; B01D 2256/16; B01D 2256/24; B01D 2257/702; B01D 2257/7025; B01D 2256/245

(57) ABSTRACT

The invention provides a process for treating a gas stream comprising hydrogen, methane and C₂+ hydrocarbons comprising sending the gas stream to a pressure swing adsorption unit to produce a first purified gas stream comprising hydrogen and methane and a second purified gas stream comprising hydrogen, methane and C₂+ hydrocarbons, sending the first purified gas stream to a second pressure swing adsorption unit to produce a hydrogen product stream comprising more than 99 mol % hydrogen and a fuel gas stream comprising more than 90 mol % of the methane in the first product gas stream, and sending the second purified gas stream to a gas plant to be separated into a plurality of streams.

### CROSS-REFERENCE TO RELATED APPLICATION

This application claims priority from Provisional Application No. 62/017,827 filed Jun. 26, 2014, the contents of which are hereby incorporated by reference.

### BACKGROUND OF THE INVENTION

The invention provides a process for treating gases containing hydrogen, methane and C₂+ hydrocarbons to recover hydrogen gas to produce a pure hydrogen stream, methane to be used as fuel gas or other application and C₂+ hydrocarbons to be sent to a steam cracker.

### SUMMARY OF THE INVENTION

The invention provides a process for treating a gas stream comprising hydrogen, methane and C₂+ hydrocarbons comprising sending the gas stream to a pressure swing adsorption unit in order to produce a first purified gas stream comprising hydrogen and methane and a second purified gas stream comprising hydrogen, methane and C₂+ hydrocarbons, sending the first purified gas stream to a second pressure swing adsorption unit to produce a hydrogen product stream comprising more than 99 mol % hydrogen and a fuel gas stream comprising more than 90 mol % of the methane in the first product gas stream, and sending the second purified gas stream to a gas recovery unit (“gas plant”) to be separated into a plurality of streams.

### BRIEF DESCRIPTION OF THE DRAWINGS

FIG. 1 shows a prior art base gas processing flow scheme.

FIG. 2 shows a flow scheme with a two-stage pressure swing adsorption train and tail gas sent to a gas plant.

FIG. 3 shows an alternative flow scheme with a two-stage PSA train and tail gas to a gas plant and lean gas from the gas plant sent to another two-stage PSA train.

### DETAILED DESCRIPTION OF THE INVENTION

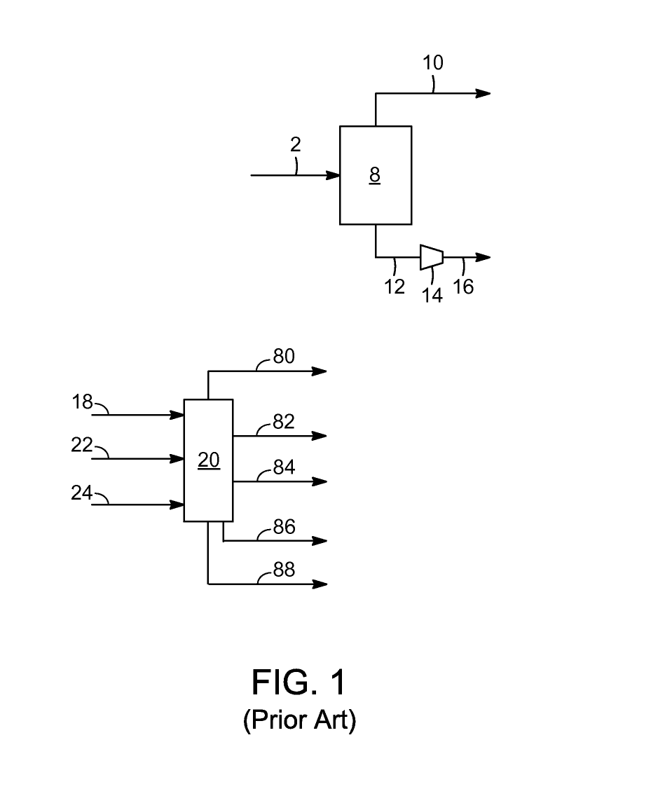

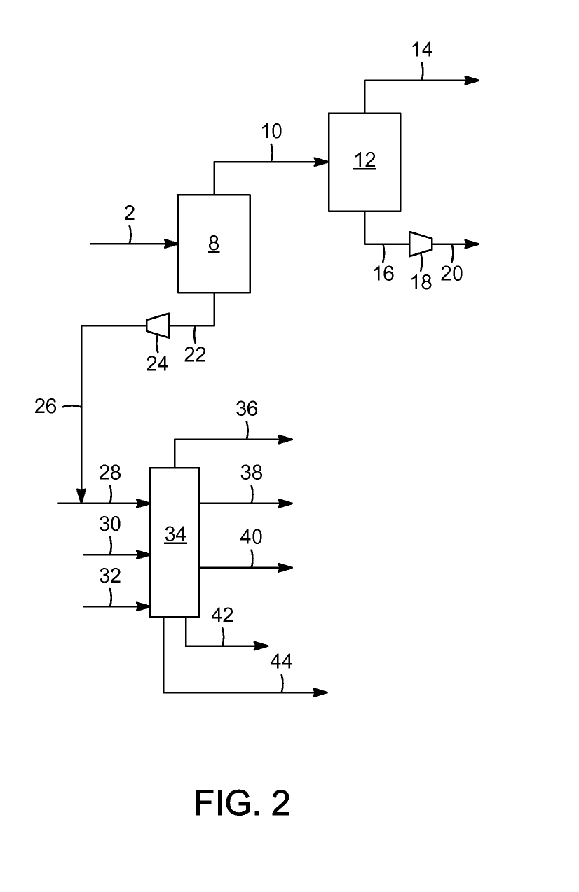

An example base scheme for a gas processing section within an integrated refinery and steam cracker complex is shown in FIG. 1. This section generates some high-purity hydrogen and fuel gas, but its main value is in the preparation of feed to the steam cracker. Steam crackers convert hydrocarbon feedstock to streams rich in light alkenes like ethylene and propylene and are used as a principal industrial means to generate these valuable petrochemical products. The feed gas in FIG. 1 is composed of separator off gases from various hydroprocessing units within the complex (“flash drum gases”), as well as off gases from the crude unit and stripper column off gases from the hydroprocessing units (“stripper gases”), and it consists of a mix of hydrogen and hydrocarbons (primarily saturated C₁-C₄). The stripper gases are processed in a gas plant that includes distillation columns and other separation apparatus to separate the different hydrocarbons for further processing. Unstabilized gasoline (“wild naphtha”) and lean oil from elsewhere in the complex are also commonly directed to the gas plant to participate in the separation. In a typical configuration, the plant produces a light gas stream that comprises primarily hydrogen and C₂− hydrocarbons (“lean gas”), an LPG (C₃/C₄ hydrocarbons) stream (that may be further separated into individual C₃ and C₄ hydrocarbon streams), and a naphtha stream that comprises primarily heavier hydrocarbons. The lean oil also absorbs hydrocarbons and thus becomes enriched (“rich oil”). The lean gas from the plant is afterward sent to the steam cracker. The other streams from the plant eventually may be fed to the steam cracker as well. The flash drum gases are at fairly high pressure (791 to 3204 kPa, 100 to 450 psig) and are relatively concentrated in hydrogen (30-95 mol %). These are blended and sent to a pressure-swing adsorption (PSA) unit to produce high-purity (99.9 mol %) hydrogen and a tail gas stream that is used for fuel gas in many typical designs. However, this can waste a lot of potential value, as the fuel gas contains an appreciable amount of C₂+ hydrocarbons (C₂+ as used herein refers to ethane and heavier hydrocarbons) that would be quite attractive as steam cracker feed. This invention proposes a two-stage PSA separation scheme (FIG. 2) to establish an improved feed for the steam cracker. As much as all of the C₂+ hydrocarbons previously going to fuel gas are shifted to the steam cracker, thereby greatly enhancing product value. At the same time, the hydrogen and methane in the feed to the steam cracker, which waste capacity and energy without being converted into high-value petrochemical products, are minimized. In the new scheme, the combined flash drum gases are sent to a first PSA unit. This unit operates to separate out both hydrogen and methane while maximizing the recovery of C₂+ hydrocarbons to the tail gas. This low-pressure gas, which is depleted in hydrogen and methane, is then compressed and mixed with the stripper gases for processing in the gas plant. The high-pressure PSA product stream goes to a second PSA unit, where it is separated into 99.9 mol % hydrogen and tail gas that can be compressed and used for fuel gas.

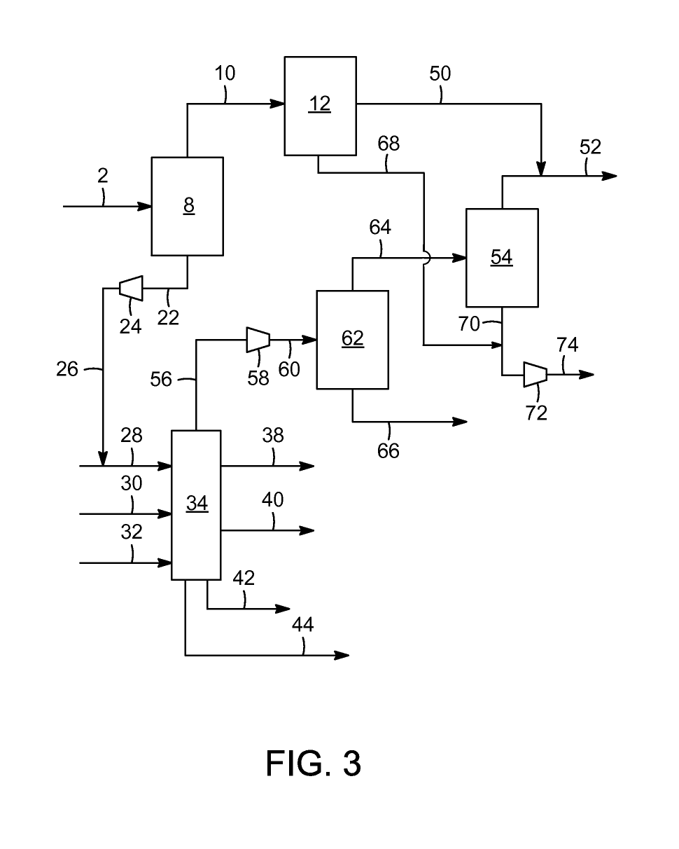

The following assessment is based on the diagram in FIG. 2, but other conditions and configurations are possible. For instance, the lean gas from the gas plant is sent to the steam cracker in FIG. 2, but it could be compressed and sent through another two-stage PSA scheme (FIG. 3). This additional processing could result in greater hydrogen recovery and also further unload hydrogen/methane from the steam cracker. Finally, a two-stage PSA process is described, but more stages could be included to extend the concept and further strip methane.

FIG. 1 shows a base gas processing flow scheme that has previously been employed. Flash drum gas blend 2 that comprises 81 mol % hydrogen, 2 mol % hydrogen sulfide, less than 1 mol % water, 8 mol % methane and 9 mol % C₂+ hydrocarbons is sent to a pressure swing adsorption unit 8. In this example, there is a flash drum gas blend from hydroprocessor units in a refinery with flow rate of 139 MT/day, 18.2 MT-mole/day and 16406 m³/day (15 MMSCFD) at 52° C. (125° F.) and 3018 kPa (423 psig). From PSA unit 8, there is a pure hydrogen stream 10 that is 99.9% hydrogen that is produced at a rate of 27 MT/day and 13.3 MT-mole/day. A fuel gas stream 12 is shown exiting through compressor 14 and compressed fuel gas stream 16. The fuel gas stream comprises 30 mol % hydrogen, 8 mol % hydrogen sulfide, 2 mol % water, 28 mol % methane and 32 mol % C₂+ hydrocarbons. A stripper gas blend 18, a wild naphtha stream 22 and a lean oil stream 24 is shown being sent to gas plant 20. The stripper gas blend comprises 59 mol % hydrogen, 5 mol % hydrogen sulfide, 1 mol % water, 7 mol % methane and 28 mol % C₂+ hydrocarbons that is at a flow rate of 232 MT/day, 12.4 MT-mole/day. The wild naphtha stream 22 is at a rate of 9060 MT/day and 96 MT-mole/day and lean oil stream 24 is at 559 MT/day and 3.6 MT-mole/day. The product streams produced from the gas plant are lean gas stream 80 (124 MT/day, 11.1 MT-mole/day), C₃ hydrocarbons stream 82 (142 MT/day, 3.2 MT-mole/day), C₄ hydrocarbons stream 84 (671 MT/day, 11.5 MT-mole/day), rich oil stream 86 (613 MT/day, 4.6 MT-mole/day) and naphtha stream 88 (8298 MT/day, 82 MT-mole/day). The lean gas, C₃ hydrocarbons, C₄ hydrocarbons, rich oil and naphtha are sent to a steam cracker (not shown), after additional treatment if necessary. The lean gas 80 comprises 66 mol % hydrogen, 9 mol % hydrogen sulfide, less than 1 mol % water, 10 mol % methane and 15 mol % C₂+ hydrocarbons.

FIG. 2 provides a flow scheme with a two-stage PSA train and tail gas to a gas plant. A flash drum gas blend 2 (81 mol % hydrogen, 2 mol % hydrogen sulfide, less than 1 mol % water, 8 mol % methane and 9 mol % C₂+ hydrocarbons) (139 MT/day, 18.2 MT-mole-day) (16406 m³/day (15 MMSCFD) flow at 52° C. (125° F.) and 3018 kPa (423 psig)) is sent to a first pressure swing adsorption unit 8 to be divided into a mostly hydrogen stream 10 (92 mol % hydrogen, 8 mol % methane and less than 0.1 mol % C₂+ hydrocarbons) (14076 m³/day (12 MMSCFD)) and a stream 22 that contains most of the C₂+ hydrocarbons (34 mol % hydrogen, 11 mol % hydrogen sulfide, 3 mol % water, 8 mol % methane and 45 mol % C₂+ hydrocarbons) (136 kPa (5 psig), 68500 m³/day (3 MMSCFD)). The mostly hydrogen stream 10 is sent to a second pressure swing adsorption unit 12 to produce a high quality hydrogen stream 14 (25 MT/day, 12.2 MT-mole/day, 99.9 mol % hydrogen) and fuel gas stream 16 that is sent to a compressor 18 to be increased in pressure from 136 to 584 kPa (5 to 70 psig) to compressed fuel gas stream 20 (21 MT/day, 2.5 MT-mole/day, 17890 m³/day (2.1 MMSCFD) (55 mol % hydrogen, 45 mol % methane and 0.3 mol % C₂+ hydrocarbons). The stream 22 is sent through compressor 24 to compressed stream 26 and then combined with stripper gas blend 28. Stripper gas blend 28 comprises 59 mol % hydrogen, 5 mol % hydrogen sulfide, 1 mol % water, 7 mol % methane and 28 mol % C₂+ hydrocarbons. Stripper gas blend 28, which now includes the content of stream 22 is sent to a gas plant 34 together with wild naphtha stream 30 (9060 MT/day, 96 MT-mole/day) and lean oil stream 32 (692 MT/day, 4.5 MT-mole/day). The gas plant 34 consists of a number of distillation columns and other separation apparatus to produce a number of streams including lean gas stream 36 (62 mol % hydrogen, 9 mol % hydrogen sulfide, less than 1 mol % water, 10 mol % methane and 17 mol % C₂+ hydrocarbons) (168 MT/day, 13.7 MT-mole/day), C₃ hydrocarbons stream 38 (155 MT/day, 3.5 MT-mole/day), C₄ hydrocarbons stream 40 (684 MT/day, 11.7 MT-mole/day), rich oil stream 42 (765 MT/day, 5.8 MT-mole/day) and naphtha stream 44 (8301 MT/day, 82 MT-mole/day). Lean gas stream 36, C₃ hydrocarbons stream 38, C₄ hydrocarbons stream 40, rich oil stream 42 and naphtha stream 44 are all sent to a steam cracker (not shown), after additional treatment if necessary.

FIG. 3 provides an alternative flow scheme with a two-stage PSA train and tail gas to a gas plant and lean gas from the gas plant sent to another two-stage PSA train. A flash drum gas blend 2 (16406 m³/day (15 MMSCFD) at 52° C. (125° F.), 3018 kPa (423 psig)) is sent to a first pressure swing adsorption unit 8 to be divided into a mostly hydrogen stream 10 and a stream 22 that contains most of the C₂+ hydrocarbons. The mostly hydrogen stream 10 is sent to a second pressure swing adsorption unit 12 to produce a high quality hydrogen stream 50 and a fuel gas stream 68. The stream 22 that contains C₂+ hydrocarbons is sent through compressor 24 to compressed stream 26 and then combined with stripper gas blend 28. Stripper gas blend 28 is at 40° C. (104° F.) and 584 kPa (70 psig). Stripper gas blend 28, which now includes the content of stream 26 is sent to a gas plant 34 together with wild naphtha stream 30 and lean oil stream 32. The gas plant 34 consists of a number of distillation columns and other separation apparatus to produce a number of streams including lean gas stream 56, C₃ hydrocarbons stream 38, C₄ hydrocarbons stream 40, rich oil stream 42 and naphtha stream 44. C₃ hydrocarbons stream 38, C₄ hydrocarbons stream 40, rich oil stream 42 and naphtha stream 44 are all sent to a steam cracker (not shown), after additional treatment if necessary. Among the differences in FIG. 3 from FIG. 2, is that a lean gas stream 56 is sent from the gas plant 34 to compressor 58 to a compressed lean gas stream 60 to another PSA unit 62 in which a hydrogen/methane stream 64 is sent to yet another PSA unit 54 and a tail gas stream 66 that is sent to a steam cracker. A 99.9 mol % hydrogen stream 52 is sent from PSA unit 54 and is combined with a hydrogen stream 50. A tail gas stream 70 at 136 kPa (5 psig) is sent to a compressor 72 after being combined with a 136 kPa (5 psig) tail gas stream 68 from PSA unit 12 to become fuel gas stream 74.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

### SPECIFIC EMBODIMENTS

While the following is described in conjunction with specific embodiments, it will be understood that this description is intended to illustrate and not limit the scope of the preceding description and the appended claims.

A first embodiment of the invention is a process for treating a gas stream comprising hydrogen, methane and C₂+ hydrocarbons comprising sending the gas stream to a pressure swing adsorption unit to produce a first purified gas stream comprising hydrogen and methane and a second purified gas stream comprising hydrogen, methane and C₂+ hydrocarbons, sending the first purified gas stream to a second pressure swing adsorption unit to produce a hydrogen product stream comprising more than 99 mol % hydrogen and a fuel gas stream comprising more than 90 mol % of the methane in the first purified gas stream, and sending the second purified gas stream to a gas plant to be separated into a plurality of streams. An embodiment of the invention is one, any or all of prior embodiments in this paragraph up through the first embodiment in this paragraph wherein the plurality of streams comprises a lean gas stream, a C₃ hydrocarbons stream, a C₄ hydrocarbons stream, a rich oil stream and a naphtha stream comprising C₅+ hydrocarbons. An embodiment of the invention is one, any or all of prior embodiments in this paragraph up through the first embodiment in this paragraph wherein the lean gas stream, the C₃ hydrocarbons stream, the C₄ hydrocarbons stream, the rich oil stream, and the naphtha stream are sent to a steam cracker. An embodiment of the invention is one, any or all of prior embodiments in this paragraph up through the first embodiment in this paragraph wherein the fuel gas stream comprises about 55 mol % hydrogen, 45 mol % C₁ and 0.3 mol % C₂+ hydrocarbons. An embodiment of the invention is one, any or all of prior embodiments in this paragraph up through the first embodiment in this paragraph wherein the lean gas stream is sent to a third pressure swing adsorption unit to produce a tail gas stream comprising C₂+ hydrocarbons and a hydrogen/methane stream. An embodiment of the invention is one, any or all of prior embodiments in this paragraph up through the first embodiment in this paragraph wherein the hydrogen/methane stream is sent to a fourth pressure swing adsorption unit to produce an additional hydrogen stream comprising more than 99 mol % hydrogen and an additional fuel gas stream comprising hydrogen and methane.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A process for treating a gas stream comprising hydrogen, methane and C₂+ hydrocarbons comprising sending said gas stream to a pressure swing adsorption unit to produce a first purified gas stream comprising hydrogen and methane and a second purified gas stream comprising hydrogen, methane and C₂+ hydrocarbons, sending said first purified gas stream to a second pressure swing adsorption unit to produce a hydrogen product stream comprising more than 99 mol % hydrogen and a fuel gas stream comprising more than 90 mol % of said methane in said first purified gas stream, and sending said second purified gas stream to a gas plant to be separated into a plurality of streams.

2. The process of claim 1 wherein said plurality of streams comprises a lean gas stream, a C₃ hydrocarbons stream, a C₄ hydrocarbons stream, a rich oil stream and a naphtha stream comprising C₅+ hydrocarbons.

3. The process of claim 2 wherein said lean gas stream, said C₃ hydrocarbons stream, said C₄ hydrocarbons stream, said rich oil stream, and said naphtha stream are sent to a steam cracker.

4. The process of claim 1 wherein said fuel gas stream comprises about 55 mol % hydrogen, 45 mol % C₁ and 0.3 mol % C₂+ hydrocarbons.

5. The process of claim 2 wherein said lean gas stream is sent to a third pressure swing adsorption unit to produce a tail gas stream comprising C₂+ hydrocarbons and a hydrogen/methane stream.

6. The process of claim 5 wherein said hydrogen/methane stream is sent to a fourth pressure swing adsorption unit to produce an additional hydrogen stream comprising more than 99 mol % hydrogen and an additional fuel gas stream comprising hydrogen and methane.
